(19) United States
(12) Patent Application Publication
(10) Pub. No.: US 2012/0119709 A1
(43) Pub. Date: May 17, 2012

(54) BATTERY PACK BALANCING CIRCUIT

(75) Inventors: Benjamin C. Mull, San Jose, CA (US); Hrag Kasparian, Glendale, CA (US)

(73) Assignee: TENERGY CORPORATION, Fremont, CA (US)

(21) Appl. No.: 13/299,253

(22) Filed: Nov. 17, 2011

Related U.S. Application Data
(60) Provisional application No. 61/414,609, filed on Nov. 17, 2010.

(51) Int. Cl. H02J 7/00

(52) U.S. Cl. 320/149

(57) ABSTRACT

A battery management balancing device provides local discharge circuits for individual cells of a battery pack, where the discharge circuits include a power transistor. The use of a power transistor yields a controllable balancing current through that transistor between a cathode and anode of the individual cell. A microcontroller monitors a state of charge of each cell, such as by measuring the cell voltages, and provides control signals, for example indicating a target voltage for each cell, that drive the power transistors in designated discharge circuits.

### CROSS-REFERENCE TO RELATED APPLICATION

The present invention claims priority under 35 U.S.C. 119(e) from prior U.S. Provisional Application No. 61/414,609, filed Nov. 17, 2010.

### TECHNICAL FIELD

The present invention relates to rechargeable batteries and specifically to circuit arrangements or systems for battery charging or discharging, as in charger structures for battery packs, as well as battery management systems, and more particularly to battery balancing devices that balance the state of charge of individual cells in a battery pack.

### BACKGROUND ART

Battery balancing is a technique used to equalize the state of charge of individual cells in a battery pack (comprised of series-connected cells). Typically, the various cells when manufactured have slightly different storage capacities and states of charge. Also, the battery pack may become unbalanced over time from repeated cycles of charging and discharging due to differences in internal impedance. A battery's characteristics (voltage, current) may vary over charge cycle, load cycle, and lifetime due to many factors including internal chemistry, charge or discharge current, and temperature. Without balancing, the discharging of the battery pack will necessarily stop when that cell with the lowest capacity is empty, even if other cells still have some remaining charge. This limits the amount of charge that may be drawn from a battery pack. Worse, if the battery drain current is high enough, when one cell completely discharges ahead of the rest, the live cells may apply a reverse current to the discharged cell which can damage and significantly shorten the life of that cell and of the overall battery pack. Moreover, battery health (ability to accept a charge) may degrade unevenly if the individual cells in a pack do not cycle through nearly equal depths of discharge and states of charge. By balancing the state of charge of all cells in a battery pack, battery life is prolonged. Battery balancing may be part of a more comprehensive battery management system.

In the battery balancing technique, more fully charged cells are either discharged via resistors to ground (passive balancing) or redistributed to other still under-charged cells (active balancing). Current battery management systems employ a microcontroller programmed with appropriate algorithms. The controller monitors the state of charge of individual cells, e.g. by sensing the cell voltages, and then signals a switching mechanism to turn relays on and off to establish a balancing current for either passive or active balancing.

One drawback to the current art is that balancing occurs relatively slowly (over several hours) due to the use of power resistors and relays. Additionally, present systems are generally incapable of precise control of the balancing current due to cell voltage fluctuations throughout the charge and discharge cycle, as well as voltage sag inherent in the dynamics of the battery. They are basically on-off-type control systems via their relay switching mechanism. This prevents precise balancing and typically produces “ringing” in the cell voltages.

### SUMMARY DISCLOSURE

A battery management balancing device is provided that employs a series of transistors in place of both on-off switches and resistors so as to establish a balancing current that can be precisely controlled, together with microcontroller circuitry employing advanced control algorithms that eliminate ringing and offset in battery management balancing. Local feedback control loops associated with each cell or group of cells enable complete regulatory control of the set point voltages and elimination of offset between cells. Battery balancing is enabled after an average or single maximum cell voltage set point threshold has been reached. A specified cell voltage value triggers a balancing current so that the cell does not exceed a maximum allowable voltage. Termination of balancing occurs only when the entire charge cycle ends (including the termination of CV stage of charging). This ensures that balancing will continue during the entire CV stage of charging.

The battery management balancing device includes both a microcontroller and a series of power transistors (such as bipolar Darlington transistors). The microcontroller is in communication with the individual cells of a battery pack to receive data signals on sensor data inputs, where the signals are indicative of the respective cells' state of charge. The signals from the individual cell measurements may be communicated through a set of analog-to-digital converters, data and address encoders, and multiplexers. The microcontroller also has control outputs in communication with respective control inputs of the power transistors. Each power transistor is connected to its dedicated cell to provide a controllable balancing current between that cell's cathode and anode. The microcontroller, through the control signals provided onto its control outputs, individually drives the balancing currents of various power transistors. The various control outputs from the microcontroller may be communicated to the power transistors for designated cells through a set of address decoders, demultiplexers, and digital-to-analog converters. The microcontroller may also provide a charge control signal to a battery pack charger that is operative to slow or cease charging of a battery pack under certain designated conditions.

A cell's voltage (the electric potential difference between its cathode and anode terminals) is a primary indicator of its state of charge and therefore may be used as a basis for controlling the balancing current supplied through the power transistors. All power transistors may be maintained in an off condition as long as the average cell voltage of all cells in a battery pack, as well as a maximum difference in cell voltages, both indicated through the sensor data signals, are below respective user-selected threshold levels. A local feedback system for each cell may include a differential amplifier that receives a target voltage level as the control signal from the microcontroller, which is compared to an actual voltage level of the cell to provide a differential output that controls the power transistor for that cell. Additionally, an associated temperature measurement device may limit or disable the balancing current, as well limit or disable the charging current to a cell, whenever a measured temperature exceeds some designated threshold.

The use of power transistors for the balancing current and a microcontroller responsive to state of charge conditions allows greater control of balancing of the cells of a battery pack than previously achieved.

### BRIEF DESCRIPTION OF THE DRAWINGS

FIG. 1 is an electrical schematic of an embodiment of a battery management balancing device in accord with the present invention.

FIG. 2 is a close-up of the local feedback system provided with the power transistor for a representative cell of a battery pack. This local feedback system is part of the balancing device of FIG. 1.

FIGS. 3A-3B and 4A-4B are graphs of average voltage and maximum voltage difference versus time for both the known prior art and the present invention.

### DETAILED DESCRIPTION OF THE INVENTION

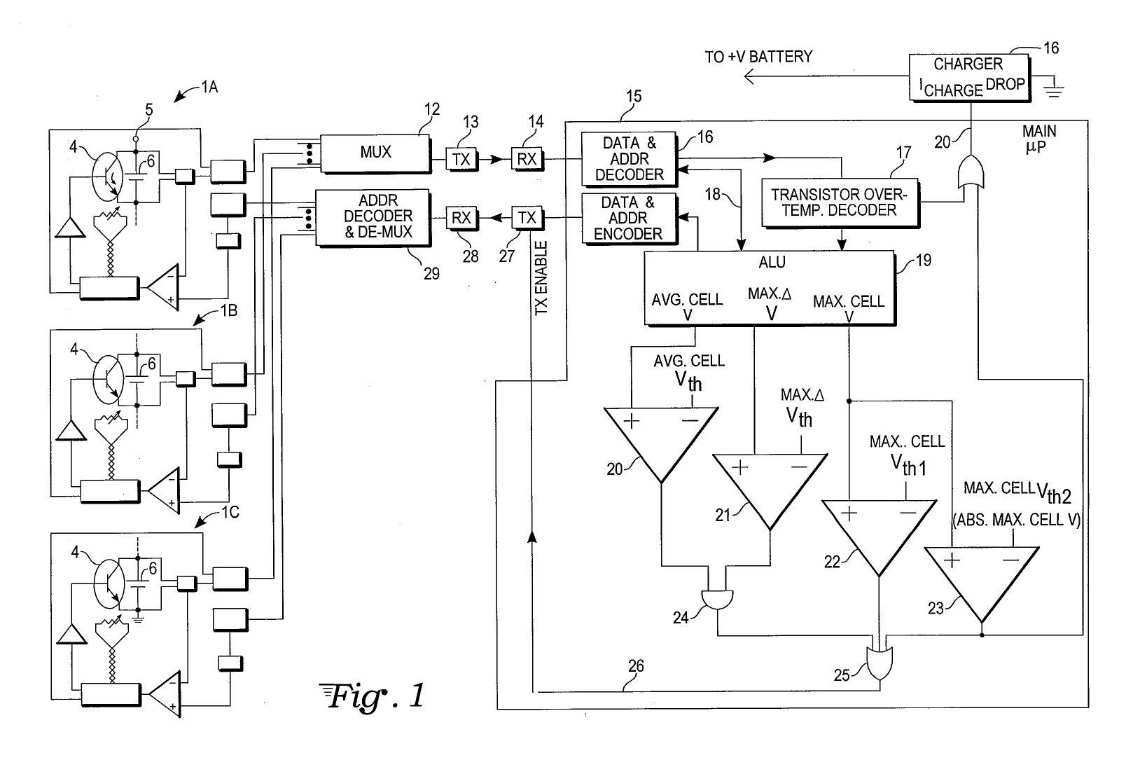

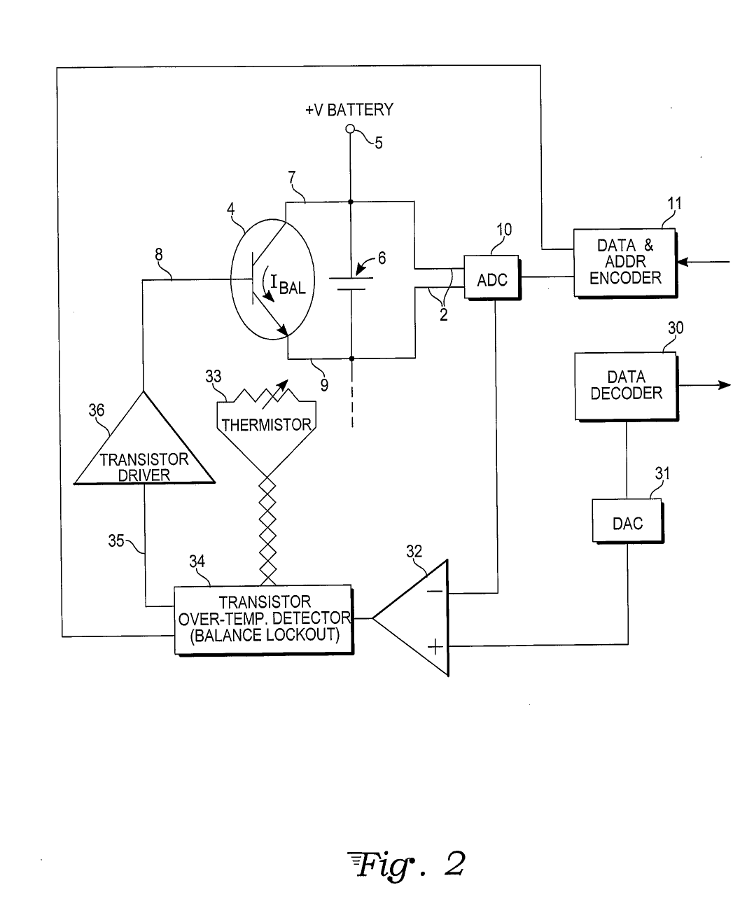

With reference to FIGS. 1 and 2, a battery management balancing device has microprocessor circuitry 15 that compares individual cell voltages and makes the battery management decisions for the cells 6 in a battery pack. The decisions of the microprocessor 15 are sent to battery balancing circuits 1A, 1B . . . 1C dedicated to the individual cells 6. The microprocessor 15 may also signal through a charger control output 20 to a charger 16 to slow or cease charging of the cells 6. Any number of cells 6 in series is theoretically possible. However, practical considerations of the application and voltage safety will limit the number of cells that will be connected in series.

The microprocessor circuitry 1 compares individual cell 6 voltages via any number of sensor leads 2 that are connected to every positive and negative cell 6 terminal in the battery pack. The analog voltage signals from the sensor leads 2 are converted to digital signals via analog-to-digital converters (ADCs) 10 in the respective balancing circuits 1A, 1B . . . 1C, and the resulting digital signals are encoded by a data and address encoder 11, then multiplexed by a multiplexer 12, before being transmitted over a communication link (represented here by transmitter (TX) 13, a wired, fiberoptic or RF communication line, and a receiver (RX) 14) to the microprocessor 15.

The microprocessor 15, after decoding the digital data in a data and address decoder 16 of the microprocessor 15, then compares the measured voltages in an arithmetic-logic unit (ALU) 19 to obtain values for average cell voltage, maximum voltage difference and maximum cell voltage. It then employs a regulatory control algorithm to regulate the difference in any voltages (“Delta Vs”) to a set point, and thereby effectively render equalized voltages across all cells 6. The algorithm employed may be PI, PID, State-Space, Model

Predictive, Adaptive or any other variation of the aforementioned of other regulatory control or regulatory heuristic algorithm. The gains, or parameters shall be selected based on the particular battery sizes, chemistries, and dynamics, and the particular dynamics of the balancing discharge device 4 in the balancing circuits 1A, 1B . . . 1C.

The microprocessor 15 then transmits data and address encoded control signals. The control signals are returned over the communication link (TX 27 and RX 28) then decoded and de-multiplexed 29 to the appropriate balancing circuit 1A, 1B . . . 1C. Multiplexed signals are only passed if the system is requesting a balancing circuit 1A, 1B . . . 1C to initiate balancing of a cell 6 and the signal's encoded data will indicate the goal voltage value for cell balancing. The digital control signals are converted to analog via a digital-to-analog converter 31. The architecture of FIG. 1 may be fully a single unit, as depicted, or may be architected with some distributed control boards and logic.

As seen in FIG. 2, each cell 6 has its own balancing circuit 1A, 1B . . . 1C, and within that circuit, its own dedicated discharge device(s) 4. There are, therefore, at least as many discharge devices 4 as cells 6. In certain applications, there may be multiple parallel discharge devices 4 per cell depending on the current and power capabilities of each device. Heat sinks, fans, or other cooling devices may be used to cool the discharge device 4. Depending on the heat sinks, fans, current and capacities of cells, some heat removal devices will be required.

The converted analog control signals from DAC 31 are delivered via the comparator 32 and the transistor driver 36, which will trigger the discharge device 4 to initiate or stop the discharge (balancing) current I_{BAL}. Alternatively, the analog control signal, representing a target cell voltage may be replaced with a corresponding pulse width modulation control signal with appropriate modifications of the transistor driver 38. In either case, the control signals obtained from the microprocessor 15 enables the discharge device 4 to precisely control the discharge (balancing) current. Finally, once the voltage set point or temperature set point passes a certain maximum cell voltage, a signal 20 is sent to reduce the charge current.

The discharge device 4 is preferably a bipolar transistor that contains a collector, base, and emitter, or a similar power transistor device will control the discharge (balancing) current I_{BAL}, in accordance with the level of an input signal 8 provided from the transistor driver 36. A bipolar transistor is used in lieu of a FET due to the lower driver voltages at which the bipolar transistor may operate. As one example, the bipolar transistors may be Darlington transistors. The discharge device 4 shall be sized to allow for adequate discharge (balancing) current I_{BAL} and power based on the size of the battery cells 6. The discharge (balancing) current 5 may be in the single, to hundreds of Amps.

The main microprocessor 15 sends target voltage balance values that are continually refreshed as the pack voltages change in this dynamic system. The microprocessor 15 may provide no signal at all (as determined by comparators 20-23 and logic gates 24-25 via a transmission enable/disable signal 26) if the average cell voltage, as determined by ALU 19, is below a user selected threshold level (AVG CELL V_{TH}), or if the maximum difference between cells (MAX ΔV) is below some user-selected threshold (MAX ΔV_{TH}). There will also be specific cell voltage values (MAX CELL V) that will trigger balancing so as not to exceed the maximum allowable voltage (MAX CELL V_{TH1}). This voltage threshold will be offset lower than the maximum allowable cell voltage (MAX CELL V_{TH2}), in order to allow additional speed in pack balancing.

The discharge device 4 can be precisely controlled through a feedback system local to each balancing circuit 1A, 1B . . . 1C, wherein the microprocessor only sends a target voltage to the balancing circuit and the feedback system includes a comparator 32 that responds locally to the sensed cell voltage on lines 2. This is a true dynamic passive balancing system.

There are three main ways in this example implementation of how the balancing of a cell is initiated by the system:

1. If at any time during the charge cycle of the battery pack the average cell voltage of the pack exceeds a set threshold, denoted in FIG. 1 as AVG CELL V_{TH}, as well as the maximum variance/difference between the minimum cell voltage and maximum cell voltage being greater by its selected set threshold, denoted in FIG. 1 as MAX balancing gets initiated by the microprocessor 15 sending the appropriate balance command to the cells 6 that need balancing.
2. If at any time during the charge cycle of the battery pack, any cell voltage reaches a selected set threshold, denoted in FIG. 1 as MAX CELL V_{TH1,} the microprocessor 15 will command/request the appropriate balancing circuit 1A, 1B . . . 1C to balance (discharge) its cell 6. This voltage threshold is to start balancing cells that are reaching the maximum allowable cell voltage. Balancing at this voltage threshold allows any cell 6 with this voltage to slow its rate of voltage rise in order for the rest of the cells in the battery pack to catch up. If balancing is not initiated at this voltage threshold, the cell voltage can have a runaway due to its state of charge being very near the end of charge, where there exists an exponential increase in the cell voltage. This contributes to a noticeably more efficient charging process to take place.
3. If at any time during the charge cycle of the battery pack, any cell voltage reaches the final set voltage threshold, denoted in FIG. 1 as MAX CELL V_{TH2}, the microprocessor 15 will command/request the appropriate balancing circuit 1A, 1B . . . 1C to balance (discharge) its cell 6. This voltage threshold is considered to be the absolute maximum allowable cell voltage. This state being true also triggers the charger to reduce its charging current, since at high voltages the cell balancing sub-system would likely not keep up with the aggressive voltage rate change within the cell.

A discharge current I_{BAL}, through discharge device 4 will be limited via a temperature measuring device 33 and balancing lockout 34 to prevent thermal runaway. The temperature measuring device 33 may be a thermistor, thermocouple, temperature measuring IC, or other such temperature sensor. Above a certain threshold temperature, the discharge transistor 4 will be temporarily disabled until the temperature drops. The over-temperature condition may also trigger an “over-temperature” flag from the balance lockout 34, which is added to the data sent via the data and address encoder 11 to the microprocessor 15. Once received the flag is decoded via decoder 17 and sent as a charger control signal 20 to temporarily reduce, or in worst cases stop, the charging current to the cells. Standard over-temperature safety features 16 and 17 will generally slow the rate of charge within the battery pack, but will not directly interfere with the balancing operation, which is separately controlled. As the temperature of the transistor 4 drops to safe levels, balancing of the transistor can once again commence to manage the cell voltage to desired limits, the flag will be dropped and the slowing of cell charging will end.

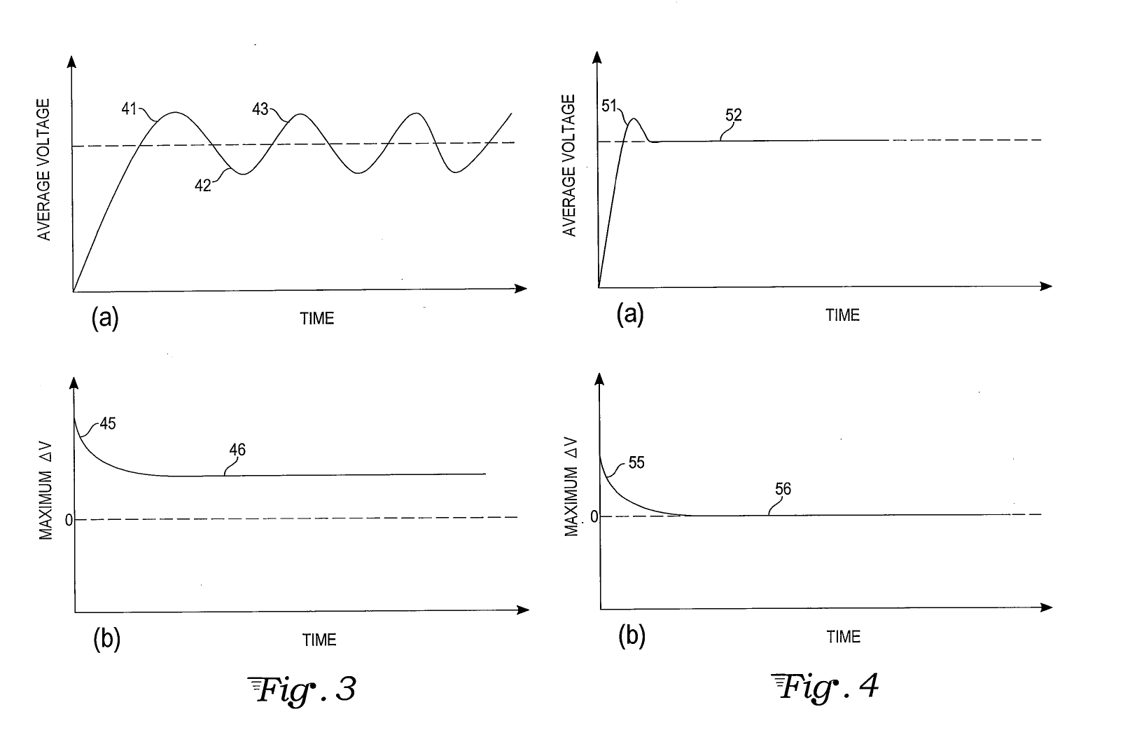

Advantages of the present invention include, without limitation, a battery management balancing device that establishes a balancing current that can be precisely controlled and will enable management balancing that may eliminate “ringing”, and set point offset. As seen in FIGS. 3A and 3B, the average cell voltages rises during the charging, but tends to overshoot the target voltage, as seen at 41. The current drain from balancing with simple switches causes ringing of the voltage, i.e. repeated oscillations of voltage at 42, 43, etc. Likewise, the balancing current can reduce the voltage imbalance between cells, as seen at 45, but in the end still leaves an offset, as seen at 46. In FIG. 4A, while the present invention's balancing operation may have an initial overshoot at 51, but the average voltage will quickly settle to the set point due to the enhanced control over the balancing current. Likewise, the offset in the pack's voltage imbalance can be eliminated as seen at 55 and 56 in FIG. 4B. This will enable expanded ability to not only quickly balance batteries, but will enable optimal performance of battery charging algorithms. Further, the optimal control of battery charging can be conducted on a cell-by-cell basis.

Variations of this specific embodiment include adaptations for active battery management balancing, in place of the passive balancing provided in the example. While the specific details will differ from the example, the various embodiments of the present invention replace power resistors and relays in the prior art circuitry with power transistors controlled by a microcontroller that senses indicators of state of charge imbalance and provides target charge controls to local circuitry that can vary the balancing current through the corresponding power transistors. Thus, greater control over balancing is achieved, for increased speed and avoidance of ringing associated with the largely uncontrolled balancing currents associated with the power resistors of the prior art.

What is claimed is:

1. A battery management balancing device, comprising:
a series of power transistors respectively connected in parallel to dedicated one's of individual cells of a battery pack, each power transistor connected to provide a controllable balancing current between a cathode and anode of its dedicated cell; and
a microcontroller having sensor data inputs in communication from individual cells to receive data signals indicative of a state of charge of each cell, the microcontroller also having control outputs in communication with control inputs of the respective power transistors so as to individually drive the balancing currents of the transistors in accord with the data signals.

2. A battery management balancing device as in claim 1, wherein the states of charge of the individual cells are indicated at least in part by a voltage between cathode and anode of those cells.

3. A battery management balancing device as in claim 1, wherein control outputs from the microcontroller maintain all power transistors in an off condition as long as an average cell voltage indicated by the sensor data signals is below a selected threshold level.

4. A battery management balancing device as in claim 1, wherein control outputs from the microcontroller maintain all power transistors in an off condition as long as a maximum difference in cell voltages indicated by the sensor data signals is below a selected threshold level.

5. A battery management balancing device as in claim 1, wherein the microcontroller further includes a charger control output coupled to a battery pack charger, the charger control output providing a charger control signal operative to slow or cease charging of the battery pack.

6. A battery management balancing device as in claim 2, further comprising a set of analog-to-digital converters coupled between the cathode and anode of respective cells with outputs of the converters providing digital signals indicative of the analog voltage between the respective cathodes and anodes of the cells.

7. A battery management balancing device as in claim 3, further comprising a multiplexer with an output connected to sensor data inputs of the microcontroller, wherein each analog-to-digital converter is in communication with inputs of the multiplexer via a data and address encoder.

8. A battery management balancing device as in claim 1, wherein the power transistors are bipolar transistors with the balancing current flowing between collector and emitter as controlled by a base current.

9. A battery management balancing device as in claim 8, wherein the bipolar transistors are Darlington transistors.

10. A battery management balancing device as in claim 1, wherein control outputs from the microcontroller are in communication with an address decoder and demultiplexer so as to supply control data to a digital-to-analog converter for a designated cell.

11. A battery management balancing device as in claim 10, wherein an output of each digital-to-analog converter is coupled to its power transistor via a transistor driver for the designated cell.

12. A battery management balancing device as in claim 1, further comprising a local feedback system for each cell, wherein the control outputs from the microcontroller designate a target voltage level for a specified cell, a differential amplifier associated with a cell, with a positive input of the amplifier coupled to receive the target voltage level for that cell and with a negative input of the amplifier coupled to receive an actual voltage level of that cell, the amplifier further having a differential output coupled to a control input of the power transistor for that cell.

13. A battery management balancing device as in claim 1, wherein each cell and its power transistor has an associated temperature measurement device, the balancing current through a power transistor being limited or disabled by the temperature measurement device whenever a measured temperature exceeds a designated threshold value.

14. A battery management balancing device as in claim 13, wherein the temperature measurement device is further operative to limit or disable a charging current to a cell whenever a measured temperature exceeds a designated maximum temperature value.
